(19) United States
(12) Patent Application Publication
(10) Pub. No.: US 2019/0144961 A1
(43) Pub. Date: May 16, 2019

(54) REAL-TIME CONTROL OF THE HEATING OF A PART BY A STEEL FURNACE OR HEAT TREATMENT FURNACE

(71) Applicant: COCKERILL MAINTENANCE & INGENIERIE S.A., Seraing (BE)

(72) Inventor: Jean-Christophe Mitais, Longjumeau (FR)

(21) Appl. No.: 16/097,862

(22) PCT Filed: Apr. 28, 2017
(86) PCT No.: PCT/EP2017/060153

§ 371 Date: Oct. 31, 2018

(30) Foreign Application Priority Data
May 2, 2016 (BE) 2016/5312
May 2, 2016 (EP) 16167875.0

(51) Int. Cl. C21D 1/34; C21D 11/00; F27D 19/00

(52) U.S. Cl. CPC C21D 1/34; C21D 11/00; F27D 19/00; F27D 2019/0087; F27D 2019/0021; F27D 2019/0028; F27D 2019/0003

(57) ABSTRACT

A method for controlled heating of a part by a steel furnace or a heat treatment furnace includes: obtaining a heating scheme defining a desired evolution of one or more indicators of a temperature of the part during heating in the furnace; providing the part to be heated to the furnace; three-dimensional digital modeling of the heating of the part, in real time and simultaneous to the heating of the part, the digital modeling being based on a discretization of a space containing the part into voxels and using current heating parameters of the furnace and a three-dimensional model of the part to be heated, the modeling including predicting the one or more indicators of the temperature of the part for a next reference time, the heating parameters of the furnace including the power, the temperature, or the settings of actuators; comparing the one or more indicators.

### CROSS-REFERENCE TO PRIOR APPLICATIONS

This application is a U.S. National Phase application under 35 U.S.C. § 371 of International Application No. PCT/EP2017/060153, filed on Apr. 28, 2017, and claims benefit to European Patent Application No. EP 16167875.0, filed on May 2, 2016, and Belgian Patent Application No. BE 2016/5312, filed on May 2, 2016. The International Application was published in French on Nov. 9, 2017 as WO 2017/191039 under PCT Article 21(2).

### FIELD

In general, the invention relates to the controlled heating of a part by a steel furnace or a heat treatment furnace, e.g., a reheating furnace. The control is done by digital modeling, simultaneous and in real time, of the heating of the part.

### BACKGROUND

U.S. Pat. No. 3,868,094 describes a heating control method for a metallurgical furnace having an upper zone and a lower zone. The method comprises measuring, in a single location, the surface temperature of a part passing through the furnace. The measuring signal is sent simultaneously to the controllers of the upper and lower zones. The controllers send signals to the burners of the furnace to maintain the desired upper and lower setpoint temperatures.

The described method suffers from the fact that it is necessary to measure the temperature of the part inside the furnace. As explained by document U.S. Pat. No. 3,868,094, the position of the probe must be chosen carefully so that it is not in the way of the parts and so that it is not damaged in case of stacking of parts in the furnace. Another drawback of the known method lies in the fact that the probe only provides the temperature of the lower surface of the part to be heated. The temperature of the upper surface is supposed to be deducible from the temperature of the lower surface by applying a simple function. This assumption is, however, simplistic, since the settings of the lower and upper zones may affect the ratio between the two surface temperatures. There is currently a need in the industry to offset these drawbacks and to provide a more suitable heating method.

### SUMMARY

In an embodiment, the present invention provides a method for controlled heating of a part by a steel furnace or a heat treatment furnace, comprising: obtaining a heating scheme defining a desired evolution of one or more indicators of a temperature of the part during heating in the furnace; providing the part to be heated to the furnace; three-dimensional digital modeling of the heating of the part, in real time and simultaneous to the heating of the part, the digital modeling being based on a discretization of a space containing the part into voxels and using current heating parameters of the furnace and a three-dimensional model of the part to be heated, the modeling comprising predicting the one or more indicators of the temperature of the part for a next reference time, the heating parameters of the furnace comprising the power, the temperature, or the settings of actuators; comparing the one or more indicators of the temperature of the part of the heating scheme with the one or more indicators of the temperature of the part that are predicted by the digital modeling for the next reference time; and following the comparison, adjusting, if necessary, the heating parameters of the furnace depending on the result of the comparison, in order to reduce a difference between the one or more indicators of the temperature of the part of the heating scheme and the one or more indicators of the temperature of the part that are predicted by the digital modeling for the next reference time.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1: shows the different levels of abstraction for controlling the heating of a part in a heat treatment furnace or a steel furnace;

FIG. 2: is a simplified diagram showing a continuous heat treatment furnace for controlled heating of a part;

FIG. 3: is a flowchart showing the steps carried out according to the invention for heating a part in a heat treatment furnace;

FIG. 4: is a simplified diagram showing a heat treatment furnace for controlled heating of several parts;

FIG. 5: is a graph showing the evolution of the temperature of a part during heating compared with the heating scheme.

### DETAILED DESCRIPTION

A first aspect of the present invention relates to a method for controlled heating of a part, for example a steel semi-finished product, for example a slab, a bloom, a billet, an ingot, a circular blank, a blank, or the like, by a steel furnace or a heat treatment furnace, comprising:
obtaining a heating scheme defining a desired evolution of one or more indicators of the temperature of the part during heating in the furnace;
providing the part to be heated to the furnace;
thermal monitoring by means of three-dimensional digital modeling of the heating of the part, in real time and simultaneous to the heating of the part, the digital modeling being based on a discretization of the space into voxels and using current heating parameters (i.e., applicable at the time of the modeling) of the furnace, a three-dimensional model of the part to be heated, preferably a model of the furnace, and comprising predicting one or more indicators of the temperature of the part for the next reference time;
comparing the one or more indicators of the temperature of the part of said heating scheme with the one or more indicators of the temperature of the part that are predicted by the digital modeling for the next reference time; and
following each comparison, adjusting, if necessary, the heating parameters of the furnace depending on the result of the comparison, in order to reduce a difference between the one or more indicators of the temperature of the part of the heating scheme and the one or more indicators of the temperature of the part that are predicted by the digital modeling for the next reference time.

The part to be heated may for example be in the form of a plate, slab, square part or the like. The part to be heated may be made from metal, including all grades of steel, from the most common qualities up to advanced steels with high mechanical strength, including stainless steels and silicon steels.

The heating parameters of the furnace may comprise, inter alia, the power, the temperature and/or the settings of the actuators, the settings controlling, for example, the fuel flow rate of the furnace and/or the speed of the part in the furnace.

The indicators of the temperature of the part are related directly or indirectly to the temperature of the part. They are generally representative of the temperature of the part to be heated. Temperature indicators directly related to the temperature may for example be the average temperature of the part, a temperature profile of the part, or a three-dimensional mapping of the temperature of the part. Temperature indicators indirectly related to the temperature for example comprise the latent heat of the part, the entropy, the enthalpy, etc.

The heating scheme may be obtained through a digital simulation taking account of the value of the one or more indicators of the temperature of the part at the inlet of the furnace, the desired value of the one or more indicators of the temperature of the part at the outlet of the furnace, a three-dimensional model for the part to be heated, optionally a model of the furnace. The digital simulation then determines the heating scheme comprising the evolution of the one or more indicators of the temperature of the part during heating and optionally the heating parameters of the furnace necessary to carry out this evolution.

The heating scheme may be obtained differently, for example, the heating scheme by reading one or several data files comprising the evolution of the one or more indicators of the temperature of the part during its heating as well as the heating parameters of the furnace that are necessary to achieve this evolution. It will be appreciated that the heating scheme does not need to be established in the location of the steel furnace or the heat treatment furnace, but may be developed elsewhere (e.g., in a computation center).

Optionally, the heating scheme defines an evolution of the one or more temperature indicators and heating parameters of the furnace that minimize energy consumption.

Preferably, the one or more indicators of the temperature defined in the heating scheme are setpoint values for the one or more temperature indicators adjusted during heating in the furnace. In other words, a control loop will act on the parameters of the furnace such that the values for the one or more current temperature indicators correspond to the setpoint values for the one or more temperature indicators.

The digital modeling that is done simultaneously to the heating of the part is done in “real time”, which means that the digital modeling is conceived so as to provide the information on the one or more temperature indicators in accordance with strict time constraints. In particular, the design of the digital modeling is done such that the predicted values of the one or more temperature indicators are updated several times before the next reference time, so as to be able to adjust the heating parameters of the furnace. In other words, the time to obtain the one or more temperature indicators through the digital modeling is much shorter than the time between two reference times. In the context of the present document, the term “reference time” refers to a moment during the heating method (beginning and end included) at which it is desired to have a match between the one or more indicators according to the heating scheme and the one or more indicators predicted by the modeling. The reference times may in particular comprise the end of the heating, times at which the part to be heated goes from one zone of the furnace to another, or other times. The reference times may be chosen based on the existing material, e.g., based on low-level regulating automatons.

The three-dimensional digital modeling requires a discretization of the space. The resulting “three-dimensional pixels” are called “voxels”. The voxels preferably have a volume smaller than 1 cm³.

The digital modeling is preferably designed so as to be able to be done on one or several graphic processors each comprising at least 1024 computing kernels, preferably at least 2048 computing kernels, still more preferably at least 4096 computing kernels.

The difference between the one or more indicators of the temperature of the heating scheme and one or more current indicators of the temperature of the part is computed in the parameter space, formed by the one or more indicators of the temperature of the part, according to a metric. The latter can be defined so as to assign a weight to each indicator of the temperature during the computation of the difference. For example, the average temperature of the part may have a weight twice as significant as that associated with its temperature profile during the computation of the difference.

Once the difference has been computed, the need for adjustment can be determined based on a tolerance threshold. If the difference is below the tolerance threshold, no adjustment is done. If the difference is above the tolerance threshold, the adjustment of the heating parameters of the furnace is done in order to reduce this difference at the subsequent reference times.

Several parts to be heated may be present in the furnace at the same time. Each of these parts may have a heating scheme. Optionally, in order for the heating scheme of each part to be as realistic as possible, the heating scheme of the part in question takes account of the one or several other parts also present in the furnace during the heating of the part.

Nevertheless, it is likely that it is impossible to satisfy each heating scheme of the parts present in the furnace simultaneously. Depending on the type of part to be heated, compliance with the heating scheme is more or less critical. Consequently, the method preferably comprises assigning a priority to the parts, which, in case of incompatibility of the heating schemes, defines which heating scheme takes priority over the others.

This priority may be assigned to each part to be heated either by a user, or automatically. One of these criteria may for example be the chemical composition of a part for which it is known that the temperature cannot exceed a certain value or the mass of a part.

The adjustment of the heating parameters is done, if applicable, in accordance with the priority assigned to each of the parts. If the parts may be “priority” or “non-priority”, the heating scheme of the priority part will be complied with, while the heating scheme of the non-priority parts will not necessarily be complied with. The adjustment of the heating parameters of the furnace for the non-priority parts is done so as not to cause the heating of each priority part to deviate from its heating scheme.

Optionally, a priority system with several priority levels (more than two) may be implemented. The adjustment of the heating parameters of the furnace will then be done cascading from the highest priority parts to the lowest priority parts. The adjustment of the heating parameters of the furnace for the lowest priority parts will be sure not to cause the heating of each highest priority part to deviate from its heating scheme.

In one preferred embodiment, the steel furnace or the heat treatment furnace is a continuous furnace, e.g., a sliding furnace, a tubular beam furnace, a walking hearth furnace, a rotary hearth furnace, etc. The furnace is preferably subdivided into several control zones, the reference times for example being the times at which the part goes from one zone to another.

A second aspect of the present invention relates to software for controlling the heating of a part by a steel furnace or heat treatment furnace. Such software comprises instructions, stored on a computer medium, which, when they are executed by hardware, will cause the hardware to carry out the method comprising:
obtaining a heating scheme defining a desired evolution of one or more indicators of the temperature of said part during heating in the furnace;
three-dimensional digital modeling of the heating of the part, in real time and simultaneous to the heating of the part, the digital modeling being based on a discretization of the space into voxels and using current heating parameters of the furnace and a three-dimensional model of the part to be heated and comprising predicting one or more indicators of the temperature of the part for the next reference time;
comparing the one or more indicators of the temperature of the part of the heating scheme with the one or more indicators of the temperature of the part that are predicted by the digital modeling for the next reference time;
following each comparison, adjusting, if necessary, the heating parameters of the furnace depending on the result of the comparison, in order to reduce a difference between the one or more indicators of the temperature of the part of the heating scheme and the one or more indicators of the temperature of the part that are predicted by the digital modeling for the next reference time; and
communicating the new heating parameters to a control center of the furnace.

The software is preferably designed to be executed in parallel on hardware comprising several computing kernels. The hardware may be made up of one or several processors each comprising preferably at least 1024 computing kernels, more preferably at least 2048 computing kernels, still more preferably at least 4096 computing kernels. The hardware preferably comprises one or several graphic processors.

The software may further comprise instructions which, when executed by hardware, ensure that the hardware implements the determination of the mesh type to be used (for example a square, triangular or hexagonal mesh) based on the geometry of the part to be heated. Furthermore, the software may be designed so as to determine the volume of voxels used by the digital modeling of the heating of the part so that a relative error of each temperature indicator of said digital simulation is less than 5%, preferably less than 1%, more preferably less than 0.5%.

The relative error for a certain type of mesh m and a certain volume V of voxels of a temperature indicator f_{V;m}(\vec{r}) can be computed by comparison with a numerical modeling of the same temperature indicator f_{V′;m}(\vec{r}) for a mesh of the same type m that is as fine as possible (V′ tends to 0):

$${ER}_{f} ( V ; {V}^{′} ) = \frac{\int {\vert {f}_{V ; m} ( \vec{r} ) - {f}_{{V}^{′} ; m} ( \vec{r} ) \vert}^{2} w ( \vec{r} ) d \vec{r}}{\int {\vert {f}_{{V}^{′} ; m} ( \vec{r} ) \vert}^{2} w ( \vec{r} ) d \vec{r}} ,$$

where the integration is done over the entire domain of the digital simulation and w(\vec{r}) is a weight factor dependent on the position.

It is possible to consider two specific cases in more detail. The first corresponds to the relative global error (RGE) where the weight factor is constant over the entire domain of the digital modeling. The second corresponds to the relative local error (RLE) where the weight factor is higher in the zones where the control of the error is considered significant and lower (or even non-existent) in the other zones.

A third aspect of the present invention relates to a steel furnace or heat treatment furnace for heating a part, comprising:
one or several detectors for measuring the current heating parameters of the furnace;
hardware with software as previously described and configured to carry out the method as previously described.

Preferably, the one or several detectors for measuring the current heating parameters comprise one or several pyrometers, one or several flow rate detectors of the fuel injected into said furnace, one or several lower heating value and Wobbe index detectors of the fuel injected into the furnace or a combination of the latter.

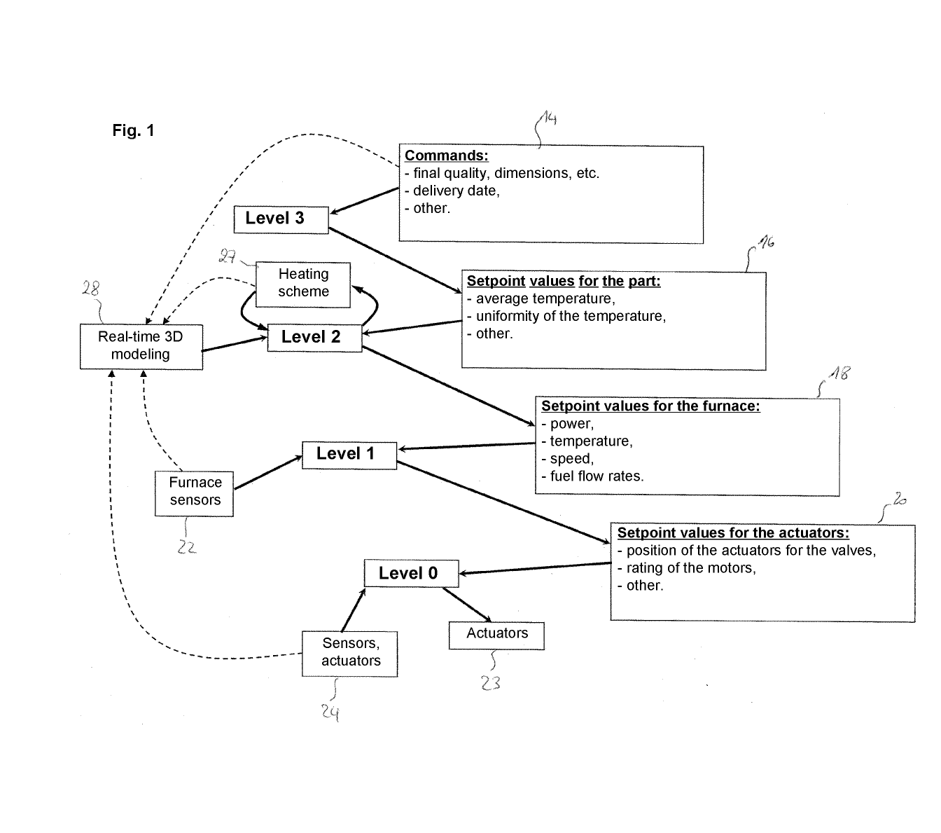

FIG. 1 is a flowchart of a method for controlling a heat treatment furnace or a steel furnace according to one embodiment of the invention. The method comprises different levels organized hierarchically. In the illustrated example, this hierarchy is made up of four levels, numbered from 0 to 3, which are described hereinafter. In one practical embodiment of the illustrated method, for example using one or several computer programs, the different levels may represent abstraction layers. In such a case, the types of inputs and outputs that it can receive, send, respectively are for example defined via a programming interface, for each abstraction layer.

At level 3, the method accepts commands 14 from clients, which for example determine the type of part, the final quality, the dimensions, the ultimate delivery date, etc. Based on commands, the setpoint values are then defined (automatically and/or manually) relative to the parts to be heated. These setpoint values may in particular comprise the final average temperature target and the temperature uniformity target. Other particularities regarding the heating of the parts may also be defined, for example a maximum temperature that may not be exceeded, a heating level to be respected, etc.

The setpoint values related to the parts to be heated are sent to level 2 of the method. At this level, the (high-level) setpoint values 18 are generated for the furnace, which for example comprise the power targets (global power and/or per zone of the furnace) and/or the targets regarding the flow rate of the fuel intended for the different burners, the temperature targets of the furnace (for the walls, exhaust gases, etc.), as well as the transit speed targets of the parts in the furnace and/or its different zones.

At level 1, the furnace is controlled so as to achieve and comply with the high-level setpoint values 18 received from level 2. The setpoint values 18 are compared to current values, indicative of the operational state of the furnace, measured by sensors 22 and/or estimated. The sensors 22 may for example comprise sensors for the temperature of the walls of the furnace, sensors measuring the temperature of the exhaust gases, fuel flow rate sensors, etc. At this level, the method therefore carries out a control loop that generates (low-level) setpoint values 20 for actuators 23 of the furnace based on high-level setpoint values 18 and the current operating state. The actuators controlled by level 1 for example comprise actuators for automatic valves controlling the fuel flow rate and/or motors controlling the forward travelling of the parts to be heated.

Level 0 has direct access to the hardware resources of the furnace and for example comprises the drivers of the hardware used, in particular that of the actuators. The translation of the low-level setpoint values 20 into electrical signals controlling the actuators 23 of the furnace in particular takes place at level 0. Level 0 may comprise control loops in order to guarantee that the actuators 23 react as expected to the level 1 commands. Such control loops may comprise sensors 24, for example sensors integrated into the actuators 23.

Functionally, each control level of the furnace may be designed as a control loop that adjusts the parameters controlled by the level in question so as to establish or maintain the compliance with the setpoint values coming from the higher level. If the current state of the level in question does not comply with the setpoint values imposed by the higher level, an adjustment of the setpoint values for the lower level is done in order to establish or reestablish the compliance.

The hierarchy of the different abstraction levels allows an operator of the furnace to program it by defining setpoint values 16 in relation with the part to be heated and/or “high-level” setpoint values 18 in relation with the furnace without having to directly program the “low-level” setpoint values.

The heating method according to the invention uses a heating scheme to program the furnace. In the hierarchical model detailed above, the establishment of the heating scheme belongs to level 2. Indeed, the heating scheme is established for a part to be heated in order to achieve the targets related to it (e.g., average temperature at the outlet of the furnace, uniformity of the temperature distribution over the entire part). The heating scheme is established by a digital simulation of the heating of the part by the furnace. The simulation uses a model of the part as well as, optionally, a model of the furnace that imitates the behavior of the furnace. The types of adjustments that the model of the furnace may undergo are identical to those that the level 2 method may perform on the actual furnace. The simulation seeking to obtain the heating scheme is carried out in the context of an optimization method of a cost function (for example, reflecting the energy consumption, the heating time or the like). In the context of this optimization method, the settings of the model of the furnace in the simulation are adjusted until a satisfactory setting is found. The heating scheme ultimately obtained contains a so-called “optimal” heating curve of the part (i.e., data indicating the evolution of the temperature of the part based on the heating progress) as well as the corresponding settings of the furnace. It will be noted that these settings will not necessarily be static, but that the heating scheme may determine an evolution of the settings based on the heating progress.

The heating scheme defines initial programming of the furnace. According to the invention, it is intended to monitor the compliance with the heating scheme through thermal monitoring done using a three-dimensional digital modeling 28 of the heating of the part, in real time and simultaneous to the heating of the part. The thermal monitoring is based, inter alia, on operational parameters (current heating parameters) of the furnace that are injected into the digital modeling, which comprises a three-dimensional model of the part to be heated as well as, optionally, a model of the furnace. If the thermal state of the part to be heated, predicted by the digital modeling, differs from the state anticipated by the heating scheme for the next reference time, an adjustment of the settings of the furnace is done. This adjustment is chosen so as to reestablish, at a later reference time (preferably the next reference time), compliance between the actual thermal state of the part and the thermal state stipulated by the heating scheme. It will be noted that this adjustment method of the settings of the furnace represents a control loop at level 2 of the aforementioned hierarchy, in which the indicators of the temperature of the part at the reference times provided by the heating scheme are setpoint values. The parameters actively adjusted by this loop advantageously comprise the fuel flow rates intended for the different burners. If these parameters are not directly accessible by level 2, they may be adjusted indirectly via power and/or temperature targets imposed at level 1.

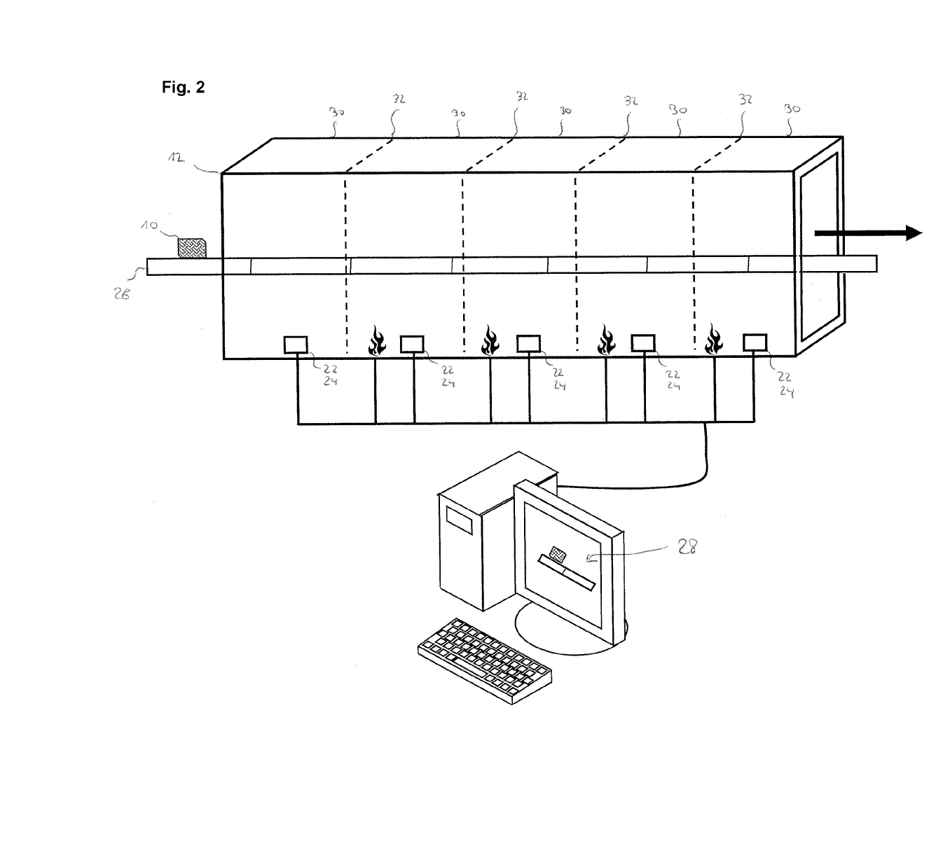

FIG. 2 shows a heat treatment furnace 12 of the continuous type used to heat a part 10 (e.g., a steel semi-finished product). The furnace 12 comprises a guideway 26 for supporting the part 10 to be heated. The furnace 12 comprises several sensors 22, 24 to measure the current heating parameters of the furnace 12. These sensors 22, 24 for example comprise one or several pyrometers for measuring the temperature of the walls of the furnace 12, one or several fuel flow rate detectors for measuring the flow of fuel injected into the burners, one or several detectors for measuring the lower heating value and/or the Wobbe index of the fuel, etc. The current heating parameters of the furnace 12 comprise quantities measured directly by the sensors 22, 24 (e.g., the current temperature of the walls of the furnace 12 or the current fuel flow rates) and/or the quantities deduced from the measurements (e.g., the current power of the furnace 12).

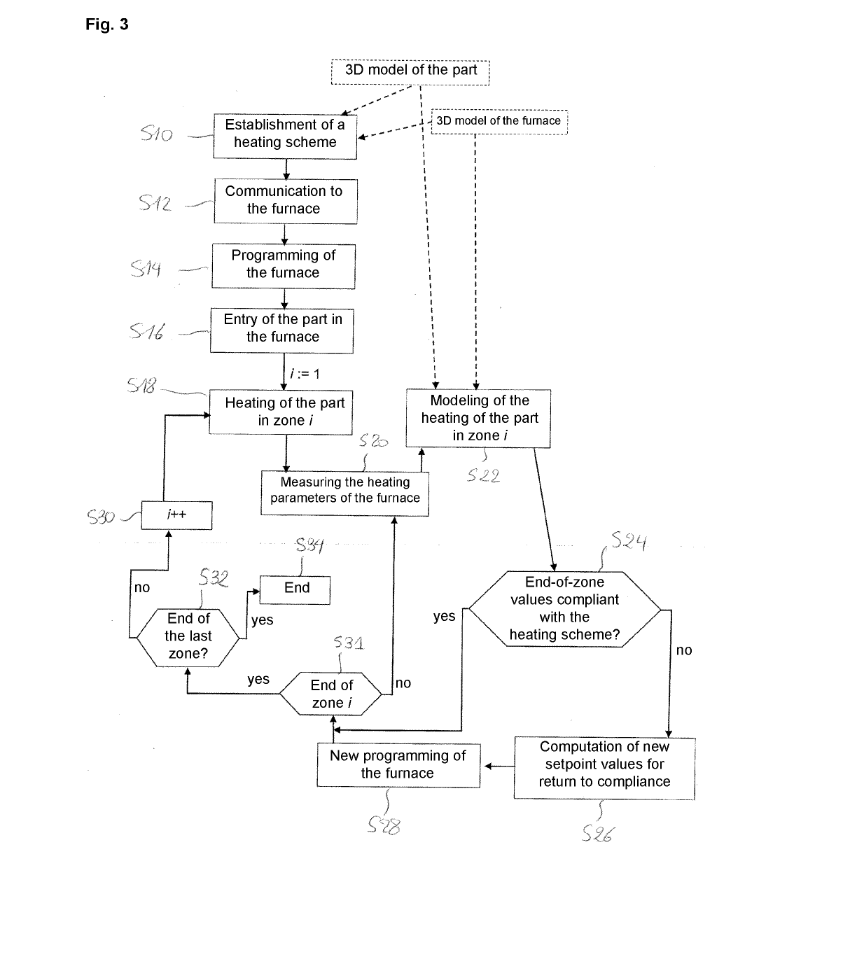

The method for heating a part by a furnace with several zones is shown in the form of a flowchart in FIG. 3.

Prior to the heating strictly speaking of the part, a heating scheme is established (step S10) by digital simulation based on a three-dimensional model of the part and, optionally, a model of the furnace. As indicated above in the text, the heating scheme defines setpoint values for the part (indications regarding the temperature of the part at the reference times), which make it possible to reach, at the end of heating, the desired final average temperature of the part and the uniformity of the desired final temperature. The heating scheme further contains the settings of the furnace, which, based on the simulation, result in the optimal heating curve of the part.

The heating scheme is transmitted to the furnace (step S12). The settings provided by the heating scheme are used to program (step S14) the furnace for the heating of the part.

The part placed on a guideway is next charged (step S16) and begins to be heated in the first zone (i=1, step S18).

As the part progresses in the furnace, the thermal monitoring of the part, in real time and simultaneous to the heating of the part, is done. Based on the current heating parameters of the furnace measured by the sensors of the furnace (step S20), the heating scheme, a model of the part, and optionally, a model of the furnace, the heating of the part in zone i is modeled and the heating state of the part at the end of zone i is predicted (step S22).

The compliance of the heating of the part with the heating scheme is verified in the next step (step S24): if the heating of the part predicted by the digital modeling for the end of zone i is in line with the heating scheme, no modification of the settings of the furnace relative to those provided by the heating scheme is necessary. Otherwise, an adjustment of the settings, intended to reestablish, at the next reference time (i.e., at the end of zone i), the compliance between the actual thermal state of the part and the thermal state stipulated by the heating scheme, is developed (step S26) and applied (step S28). It will be appreciated that steps S20, S22, S24, S26, S28 can be repeated several times over a same zone i as long as the end of zone i is not reached (step S31). In a practical example, a verification of the compliance of the heating of the part with the heating scheme could be done approximately every 10 to 60 s (e.g., every 30 s), but it will be understood that this frequency depends on several factors, in particular the complexity of the modeling and the available computing power.

If the part has not reached the end of the last zone of the furnace (verified in step S32), the part next enters the following zone of the furnace (in the flowchart, this is reflected by the incrementation of the index i in step S30). As long as the part has not reached the end of the last zone of the furnace (verified in step S32), the method described above is repeated for the new zone. The arrival of the part at the end of the last zone completes the heating of the part (step S34).

In practice, the compliance of the heating progression with the heating scheme is verified owing to the determination of a quantity characterizing the difference between the set of theoretical values (of the heating scheme) and the set of actual quantities (estimated by the modeling parallel to the heating) in relation to the reference time. The difference can be compared to a tolerance threshold in order to determine whether a correction of the settings is indicated.

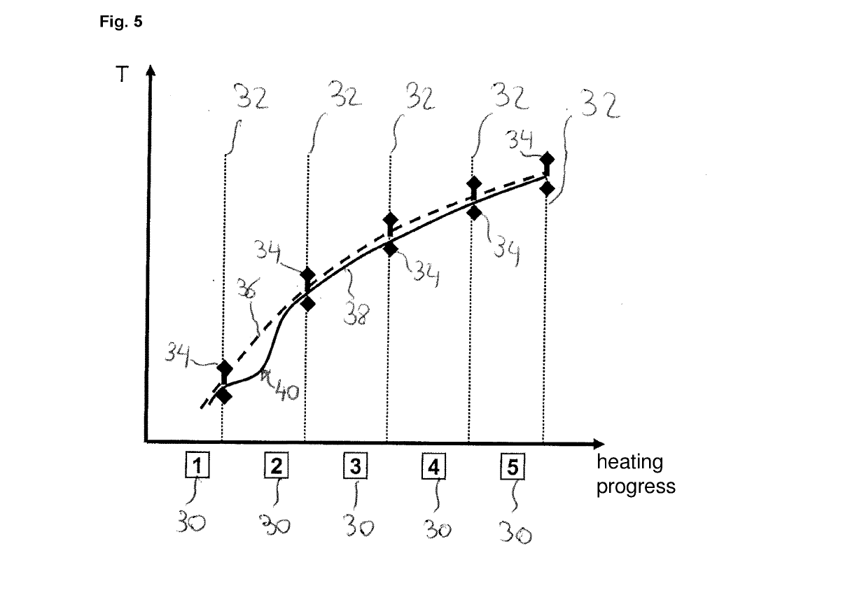

According to one embodiment of the heating scheme, the evolution of the temperature of the part is given by the average temperature of the part at the different reference times. FIG. 5 shows the average temperature 38 of the part during heating (continuous line), predicted based on the digital modeling, and the average temperature 36 of the part during heating (discontinuous line) given by the heating scheme. In the illustrated case, one can see that a significant difference between the target value and the actual value of the average temperature widens during the passage of the part in the second zone. A correction 40 of the settings of the furnace, with the aim of bringing the heating of the part in line with the heating scheme for the next reference time (steps S20, S22, S24, S26, S28, see FIG. 3), is done. In the illustrated example, no other deviation between the heating scheme and the actual heating of the part is observed.

The three-dimensional digital modeling performs thermal monitoring of the part by resolving the physical equations related, inter alia, to the heat transfers (comprising, inter alia, the heat transfers by conduction and optionally by radiation). The digital modeling is done in real time, which means that it is designed so as to provide the current temperature of the part in compliance with strict time constraints. In particular, the design of the digital modeling is done so as to guarantee (based on the computing powers implemented) that the temperature indicators predicted by the modeling are updated frequently enough before the reference times in order to be able to correct the heating parameters of the furnace to reestablish the compliance of the thermal state of the part with the heating scheme for the next reference time. Furthermore, the digital modeling is programmed so as to be able to be executed in parallel on one or more graphic processors, each of them being provided with a multitude of computing kernels.

The digital modeling of the heating of the part by the furnace on the hardware requires a discretization of the space (three-dimensional). This discretization inevitably introduces numerical imprecisions. The voxels associated with the discretization may be cubic (or another form). The larger the volume of the voxels is, the more significant the numerical error introduced by the discretization of the space may be. In case of unsuitable meshing, the estimate of the average temperature of the part obtained by digital modeling will not be representative of the actual value. As a result, the digital modeling is done with meshing in accordance with the needs. The meshing may be defined, for example, by the choice of voxels having defined forms (e.g., parallelepiped) and small enough volumes, preferably with a volume smaller than 1 cm³.

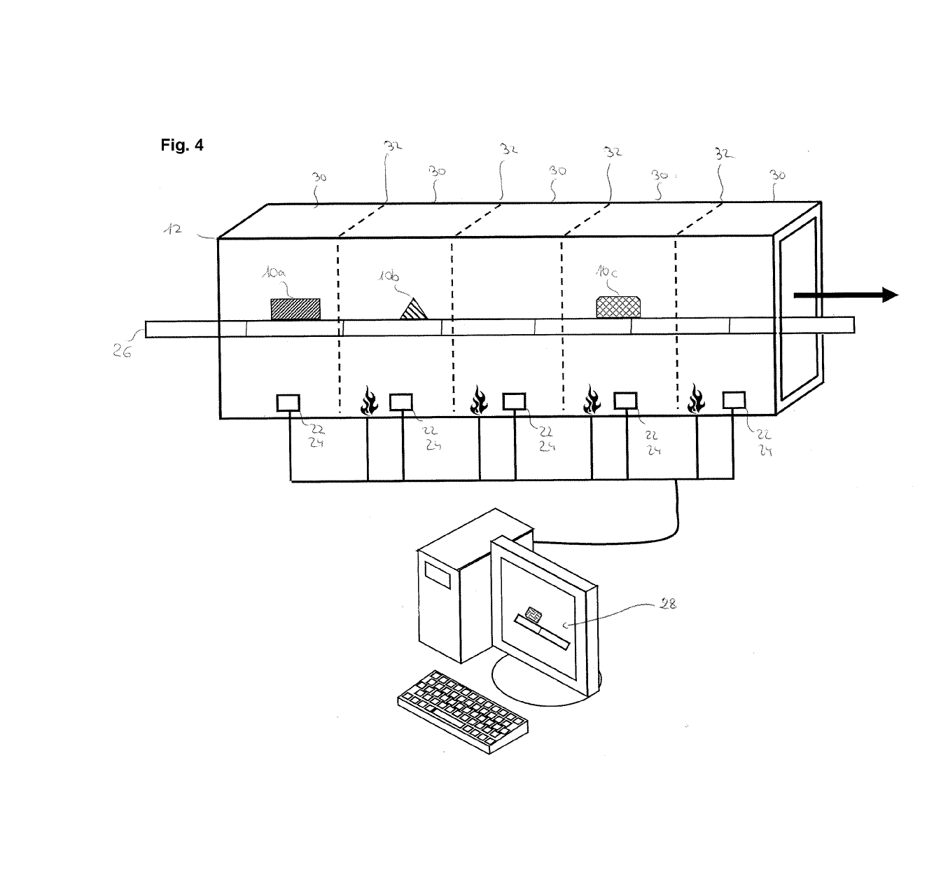

FIG. 4 illustrates the simultaneous heating of several parts 10a-10c in the furnace 12. These parts 10a-10c may have, apriori, different shapes and different chemical compositions. According to one embodiment of the invention, a heating scheme is established for each part. During the establishment of these heating schemes, account is preferably taken of the presence of other parts to be heated in the furnace at the different times.

When several parts to be heated 10a-10c, each having its heating scheme, are present at the same time in the furnace 12, the compliance of the heating of each part with its respective heating scheme is sometimes not possible. The compliance of the heating with the heating scheme may, however, be critical for certain types of parts. Priority may then be assigned to each part to be heated.

A part that has priority relative to the other parts will have its heating scheme complied with, while the heating scheme of the lower priority parts will not necessarily be complied with as long as the priority part is present in the furnace. This is due to the fact that the level 2 adjustment adjusts the settings of the furnace to ensure compliance with the heating scheme currently having priority.

Although specific embodiments have been described in detail, one skilled in the art will appreciate that various changes and alternatives thereto can be developed in light of the overall teaching provided by this disclosure of the invention. Consequently, the specific arrangements and/or methods described herein are provided solely as an illustration, with no intent to limit the scope of the invention.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of“A or B” is not exclusive of“A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A method for controlled heating of a part by a steel furnace or a heat treatment furnace, comprising:
obtaining a heating scheme defining a desired evolution of one or more indicators of a temperature of the part during heating in the furnace;
providing the part to be heated to the furnace;
three-dimensional digital modeling of the heating of the part, in real time and simultaneous to the heating of the part, the digital modeling being based on a discretization of a space containing the part into voxels and using current heating parameters of the furnace and a three-dimensional model of the part to be heated, the modeling comprising predicting the one or more indicators of the temperature of the part for a next reference time, the heating parameters of the furnace comprising the power, the temperature, or the settings of actuators;
comparing the one or more indicators of the temperature of the part of the heating scheme with the one or more indicators of the temperature of the part that are predicted by the digital modeling for the next reference time; and
following the comparison, adjusting, if necessary, the heating parameters of the furnace depending on the result of the comparison, in order to reduce a difference between the one or more indicators of the temperature of the part of the heating scheme and the one or more indicators of the temperature of the part that are predicted by the digital modeling for the next reference time.

2: The method according to claim 1, wherein the obtaining of the heating scheme comprises determining the heating scheme through a digital simulation taking account of a value of the one or more indicators of the temperature of the part at an inlet of the furnace, a desired value of the one or more indicators of the temperature of the part at an outlet of the furnace, and a three-dimensional model for the part to be heated.

3: The method according to claim 1, wherein the one or more indicators of the temperature of the part of the heating scheme comprise setpoint values for the one or more indicators of the temperature of the part during heating in the furnace, the setpoint values being used during the adjustment step.

4: The method according to claim 1, wherein the three-dimensional digital modeling of the heating of the part is done on a graphic processor comprising several computing kernels.

5: The method according to claim 4, wherein the graphic processor comprises at least 1024 computing kernel.

6: The method according to claim 1, wherein the discretization of the space for the digital modeling of the heating of the part comprises voxels with a volume of less than 1 cm³.

7: The method according to claim 1, wherein the heating scheme of the part takes account of one or several other parts also present in the furnace during the heating of the part.

8: The method according to claim 1, further comprising assigning a priority to each part to be heated by the furnace, the priority assignment being done either by a user, or automatically, the adjustment of the heating parameters taking account of the priority assigned to each of the parts.

9: The method according to claim 1, wherein the steel furnace or the heat treatment furnace comprises a continuous furnace, the steel furnace or the heat treatment furnace being subdivided into several zones, the reference times being times at which the part goes from one zone to another.

10: A computer program product, for controlling the heating of a part by a steel furnace or a heat treatment furnace, comprising a computer-readable storage medium having stored therein instructions, which, when executed by computer hardware, cause the computer hardware to implement a method, comprising:
obtaining a heating scheme defining a desired evolution of one or more indicators of a temperature of the part during heating in the furnace;
three-dimensional digital modeling of the heating of the part, in real time and simultaneous to the heating of the part, the digital modeling being based on a discretization of the space containing the part into voxels and using current heating parameters of the furnace and a three-dimensional model of the part to be heated, the modeling comprising predicting one or more indicators of the temperature of the part for a next reference time, the heating parameters of the furnace comprising the power, the temperature, or settings of actuators;
comparing the one or more indicators of the temperature of the part of the heating scheme with the one or more indicators of the temperature of the part that are predicted by the digital modeling for the next reference time;
following each comparison, adjusting, if necessary, the heating parameters of the furnace depending on the result of the comparison, in order to reduce a difference between the one or more indicators of the temperature of the part of the heating scheme and the one or more indicators of the temperature of the part that are predicted by the digital modeling for the next reference time; and
communicating the new heating parameters to the furnace.

11: A steel furnace or a heat treatment furnace for heating a part, comprising:
one or several detectors configured to measure current heating parameters of the furnace; and
computer hardware including the computer program product according to claim 10.

12: The steel furnace or the heat treatment furnace as claimed in claim 11, wherein the detectors comprise:
at least one of pyrometers and thermocouples, or
one or several flow rate detectors of a fuel injected into the furnace, or
one or several lower heating value and Wobbe index detectors of the fuel injected into the furnace, or
a combination of these detectors.

13: The method according to claim 4, wherein the graphic processor comprises at least 2048 computing kernels.

14: The method according to claim 4, wherein the graphic processor comprises at least 4096 computing kernels.

15: The method according to claim 1, wherein the settings of the actuators are configured to control at least one of a fuel flow rate of the furnace and a speed of the part in the furnace.
